(19) United States
(12) Patent Application Publication
(10) Pub. No.: US 2019/0389470 A1
(43) Pub. Date: Dec. 26, 2019

(54) SYSTEM AND METHOD FOR CONTROLLING A VEHICLE BASED ON AN ANTICIPATED LANE DEPARTURE

(71) Applicant: GM GLOBAL TECHNOLOGY OPERATIONS LLC, Detroit, MI (US)

(72) Inventors: Reza Zarringhalam, Waterloo (CA); Mohammadali Shahriari, Markham (CA); Mohammed Raju Hossain, North York (CA); Jayant Sachdev, Caledon (CA); Amir Takhmar, Toronto (CA)

(21) Appl. No.: 16/015,532

(22) Filed: Jun. 22, 2018

(51) Int. Cl. B60W 30/18

(52) U.S. Cl. CPC B60W 30/18163; B60W 2420/42; B60W 2420/52; B60W 2710/20; B60W 2520/14; B60W 2550/14; B60W 2520/105

(57) ABSTRACT

An automotive vehicle includes at least one sensor configured to detect a lane marking proximate the vehicle, and to detect velocity, acceleration, and yaw rate of the vehicle. The vehicle also includes a controller in communication with the at least one sensor and configured to selectively control a steering intervention system in a first mode and a second mode. The controller is configured to calculate a plurality of lane departure estimations at a corresponding plurality of time instances, arbitrate among the plurality of lane departure estimations to calculate a predictive time to lane departure, calculate a lane departure confidence value associated with the predictive time to lane departure, and, in response to the confidence value exceeding a first threshold and the predictive time to lane departure being below a second threshold, control the steering intervention system in the second mode.

### TECHNICAL FIELD

The present disclosure relates to vehicles having steering intervention systems configured to automatically provide intervention to avoid or deter unintended lane departures.

### INTRODUCTION

Vehicle control systems may include such arrangements as: path-following control systems, lane-boundary-keeping control systems, steering-torque assist control systems, and steering-angle assist control systems. Such traveling control systems rely on a variety of sensors, controllers and actuators, and may include the utilization of a visual lane detection system.

### SUMMARY

An automotive vehicle according to the present disclosure includes at least one sensor and a controller. The sensors are configured to detect a lane marking in the vicinity of the vehicle, to detect velocity of the vehicle, to detect yaw rate of the vehicle, and to detect acceleration of the vehicle. The controller is in communication with the at least one sensor and is configured to selectively control a steering intervention system in a first mode and a second mode. The controller is further configured to calculate a plurality of lane departure estimations at a corresponding plurality of time instances, arbitrate among the plurality of lane departure estimations to calculate a predictive time to lane departure, calculate a lane departure confidence value associated with the predictive time to lane departure, and, in response to the confidence value exceeding a first threshold and the predictive time to lane departure being below a second threshold, control the steering intervention system in the second mode.

In an exemplary embodiment, the controller is further configured to calculate a preliminary time to lane departure parameter based on a kinematic model, and to calculate the predictive time to lane departure and lane departure confidence value by filtering the preliminary time to lane departure parameter. In such embodiments, the controller may be further configured to filter the preliminary time to lane departure parameter using an estimation algorithm, e.g. an unscented Kalman filter. In such embodiments, the kinematic model may be based on a measured velocity of the vehicle, a measured acceleration of the vehicle, a measured yaw rate of the vehicle, a detected lane marking location relative to the vehicle, a detected lane marking heading relative to the vehicle, and a detected lane curvature obtained from the at least one sensor.

In an exemplary embodiment, the steering intervention system comprises an auditory, visible, or haptic operator notification system. In the first mode the steering invention system does not provide a notification, and in the second mode the steering intervention system provides a notification.

In an exemplary embodiment, the steering intervention system comprises at least one actuator configured to control vehicle steering. In the first mode the steering intervention system does not control the actuator to provide a steering torque, and in the second mode the steering intervention system controls the actuator to provide a steering torque.

In an exemplary embodiment, the at least one sensor comprises an optical camera, a LiDAR system, or a RADAR system.

A method of controlling a host automotive vehicle according to the present disclosure includes providing the host vehicle with at least one sensor, at least one controller, and a steering intervention system in communication with the at least one controller. The method also includes obtaining, from the at least one sensor, a measured velocity of the host vehicle, a measured acceleration of the host vehicle, a measured yaw rate of the host vehicle, a detected lane marking location relative to the host vehicle, a detected lane marking heading relative to the host vehicle, and a detected lane curvature. The method additionally includes calculating, via the at least one controller, a preliminary time to lane crossing parameter according to a kinematic model based on the measured velocity, measured acceleration, measured yaw rate, lane marking location, lane marking heading, and lane curvature. The method further includes filtering, via the at least one controller, the preliminary time to lane crossing parameter to obtain a final time to lane crossing value and a confidence parameter associated with the final time to lane crossing value. The method still further includes, in response to the final time to lane crossing being below a first threshold and the confidence parameter exceeding a second threshold, automatically controlling, via the at least one controller, the steering intervention system in a steering intervention mode.

In an exemplary embodiment, the filtering comprises applying an unscented Kalman filter.

In an exemplary embodiment, the steering intervention system comprises an auditory, visible, or haptic operator notification system, and wherein controlling the steering intervention system in the steering intervention mode includes controlling the steering intervention system to provide a notification.

In an exemplary embodiment, the steering intervention system comprises at least one actuator configured to control vehicle steering, and wherein controlling the steering intervention system in the steering intervention mode includes controlling the steering intervention system to provide a corrective steering torque.

In an exemplary embodiment, the filtering comprises modifying one or more non-plausible time to lane crossing calculations.

In an exemplary embodiment, the method additionally includes fusing, via the at least one controller, the preliminary time to lane crossing parameter with vehicle kinematics information, vehicle dynamics information, vehicle state information, and host vehicle lane information.

Embodiments according to the present disclosure provide a number of advantages. For example, the present disclosure provides a system and method for accurate and timely interventions based on anticipated departures from a current driving lane.

The above and other advantages and features of the present disclosure will be apparent from the following detailed description of the preferred embodiments when taken in connection with the accompanying drawings.

### BRIEF DESCRIPTION OF THE DRAWINGS

FIG. 1 is a schematic diagram of a vehicle according to an embodiment of the present disclosure;

FIG. 2 is a logic diagram illustration of method of calculating a lane departure estimation for a vehicle according to an embodiment of the present disclosure;

FIG. 3 is a logic diagram method of a system for controlling a vehicle according to a first embodiment of the present disclosure; and

FIG. 4 is a logic diagram illustration of a system for controlling a vehicle according to a second embodiment of the present disclosure.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but are merely representative. The various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

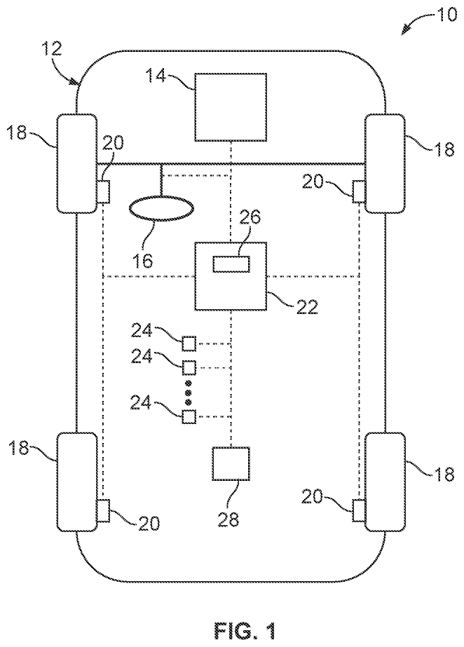

Referring now to FIG. 1, a system 10 for controlling a vehicle according to the present disclosure is shown in schematic form. The system 10 includes an automotive vehicle 12. The automotive vehicle 12 includes a propulsion system 14, which may in various embodiments include an internal combustion engine, an electric machine such as a traction motor, and/or a fuel cell propulsion system. The automotive vehicle 12 additionally includes a steering system 16. While depicted as including a steering wheel for illustrative purposes, in some embodiments within the scope of the present disclosure, the steering system 16 may omit the steering wheel. The automotive vehicle 12 additionally includes a plurality of vehicle wheels 18 and associated wheel brakes 20 configured to provide braking torque to the vehicle wheels 18. The wheel brakes 20 may, in various embodiments, include friction brakes, a regenerative braking system such as an electric machine, and/or other appropriate braking systems.

The propulsion system 14, steering system 16, and wheel brakes 20 are in communication with or under the control of at least one controller 22. While depicted as a single unit for illustrative purposes, the controller 22 may additionally include one or more other controllers, collectively referred to as a “controller.” The controller 22 may include a microprocessor or central processing unit (CPU) in communication with various types of computer readable storage devices or media. Computer readable storage devices or media may include volatile and nonvolatile storage in read-only memory (ROM), random-access memory (RAM), and keep-alive memory (KAM), for example. KAM is a persistent or non-volatile memory that may be used to store various operating variables while the CPU is powered down. Computer-readable storage devices or media may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller 22 in controlling the vehicle.

The controller 22 is in communication with a plurality of sensors 24. In an exemplary embodiment the sensors 24 include one or sensors configured to capture information about traffic lanes in the vicinity of the vehicle 12 such as RADAR, LiDAR, optical cameras, thermal cameras, and ultrasonic sensors. In addition, the sensors 24 include one or more sensors configured to detect velocity, acceleration, and yaw rate of the vehicle 12. Such sensors may include one or more inertial measurement units. The sensors 24 may also include additional sensors or any combination of the above as appropriate.

The controller 22 is provided with a lane departure algorithm 26, as will be discussed in further detail below. The lane departure algorithm 26 is configured to calculate a projected time until the vehicle 12 departs a current driving lane. The controller is in communication with an intervention system 28 configured to perform assistive, corrective, or other automated action based on an anticipated lane departure.

In a first exemplary embodiment, the intervention system 28 comprises a human-machine interface (HMI) element configured to generate a notification to a vehicle occupant, such as an audio notification, visual notification, haptic notification, or any other appropriate notification system. In such embodiments, the controller 22 may be configured to control the intervention system 28 to generate a notification in response to a lane departure condition calculated by the lane departure algorithm 26 being satisfied. Such embodiments may be referred to as a lane-departure warning system.

In a second exemplary embodiment, the intervention system 28 comprises an actuator configured to selectively apply a steering torque to the steering system 16. In such embodiments, the controller 22 may be configured to control the intervention system 28 to apply a corrective steering torque to steer the vehicle 12 away from a lane marker in response to a lane departure condition calculated by the lane departure algorithm 26 being satisfied. Such embodiments may be referred to as a lane-keeping system.

In a third exemplary embodiment, the controller 22 is provided with an automated driving system (ADS) for automatically controlling the propulsion system 14, steering system 16, and wheel brakes 20 to control vehicle acceleration, steering, and braking, respectively, without human intervention. In such embodiments, the lane departure algorithm may be incorporated into the ADS. In such embodiments, the intervention system 28 comprises an actuator configured to selectively apply a steering torque to the steering system 16, and the ADS 24 is configured to control the lane assist system 28 in response to inputs from the plurality of sensors 24.

Known configurations for lane departure algorithms may involve detecting an upcoming road geometry, comparing the detected geometry to a database containing a plurality of predefined road geometries having associated lane departure equations, arbitrating among the plurality of predefined road geometries, and calculating a time to lane departure based on the resulting lane departure equation. Such configurations may be computationally noisy.

Embodiments according to the present disclosure are configured to calculate a lane departure based on a high-fidelity kinematic model. In an exemplary embodiment, the kinematic model may be described based on a vehicle-centered coordinate system as:

\dot{x}_{Veh}=(at+V)cos(\dot{ψ}t)

and

\dot{y}_{Veh}=−(at+V)sin(\dot{ψ}t)

where the x-axis is a longitudinal (fore-aft) axis of the vehicle, the y-axis is a lateral (side-to-side) axis of the vehicle, a refers to vehicle acceleration, V refers to vehicle velocity, and \dot{ψ} refers to vehicle yaw rate.

Assuming constant velocity and yaw rate, the vehicle position may therefore be calculated as:

$${x}_{Veh} = \frac{V}{\dot{ψ}} sin ( \dot{ψ} t ) + \frac{a}{\dot{ψ}} t sin ( \dot{ψ} t ) + \frac{a}{{\dot{ψ}}^{2}} cos ( \dot{ψ} t ) - \frac{a}{{\dot{ψ}}^{2}}$$

$$and$$

$${y}_{Veh} = \frac{V}{\dot{ψ}} cos ( \dot{ψ} t ) + \frac{a}{\dot{ψ}} t sin ( \dot{ψ} t ) - \frac{a}{{\dot{ψ}}^{2}} sin ( \dot{ψ} t ) - \frac{v}{ψ}$$

The lane estimation in the vehicle-centered coordinate system may be represented by the camera as:

y_{Lane}=C₀+C₁l+C₂l²+C₃l³

where l is the look-ahead distance and can be substituted by xᵥₑₕ from above to obtain:

$${y}_{Lane} = {C}_{0} + {C}_{1} ( \frac{V}{\dot{ψ}} sin ( \dot{ψ} t ) + \frac{a}{\dot{ψ}} t sin ( \dot{ψ} t ) + \frac{a}{{\dot{ψ}}^{2}} cos ( \dot{ψ} t ) - \frac{a}{{\dot{ψ}}^{2}} ) + {{C}_{2} ( \frac{V}{\dot{ψ}} sin ( \dot{ψ} t ) + \frac{a}{\dot{ψ}} t sin ( \dot{ψ} t ) + \frac{a}{{\dot{ψ}}^{2}} cos ( \dot{ψ} t ) - \frac{a}{{\dot{ψ}}^{2}} )}^{2} + {{C}_{3} ( \frac{V}{\dot{ψ}} sin ( \dot{ψ} t ) + \frac{a}{\dot{ψ}} t sin ( \dot{ψ} t ) + \frac{a}{{\dot{ψ}}^{2}} cos ( \dot{ψ} t ) - \frac{a}{{\dot{ψ}}^{2}} )}^{3}$$

with C₀, C₁, C₂, and C₃ being third-order polynomial coefficients mapped to the detected lane markings.

The distance to lane crossing (DLC) then may be defined as:

Δr_{Veh}(t)=y_{Veh}−y_{Lane}

resulting in:

$$Δ {r}_{Veh} ( t ) = \frac{V}{\dot{ψ}} cos ( \dot{ψ} t ) + \frac{a}{\dot{ψ}} t sin ( \dot{ψ} t ) - \frac{a}{{\dot{ψ}}^{2}} sin ( \dot{ψ} t ) - \frac{v}{ψ} - {C}_{0} - {C}_{1} ( \frac{V}{\dot{ψ}} sin ( \dot{ψ} t ) + \frac{a}{\dot{ψ}} t sin ( \dot{ψ} t ) + \frac{a}{{\dot{ψ}}^{2}} cos ( \dot{ψ} t ) - \frac{a}{{\dot{ψ}}^{2}} ) - {{C}_{2} ( \frac{V}{\dot{ψ}} sin ( \dot{ψ} t ) + \frac{a}{\dot{ψ}} t sin ( \dot{ψ} t ) + \frac{a}{{\dot{ψ}}^{2}} cos ( \dot{ψ} t ) - \frac{a}{{\dot{ψ}}^{2}} )}^{2} - {{C}_{3} ( \frac{V}{\dot{ψ}} sin ( \dot{ψ} t ) + \frac{a}{\dot{ψ}} t sin ( \dot{ψ} t ) + \frac{a}{{\dot{ψ}}^{2}} cos ( \dot{ψ} t ) - \frac{a}{{\dot{ψ}}^{2}} )}^{3}$$

Considering the second order Taylor expansion of this equation around t=0 results in:

$$Δ {r}_{Veh} ( t ) = - {C}_{0} - {C}_{1} Vt - ( {C}_{2} {V}^{2} + \frac{V \dot{ψ}}{2} + \frac{{aC}_{1}}{2} ) {t}^{2}$$

The second order approximation of time to lane crossing (TTLC) based on the kinematic model may therefore be stated as:

$$Δ {r}_{Veh} ( t ) = - {C}_{0} {C}_{1} Vt - ( {C}_{2} {V}^{2} + \frac{V \dot{ψ}}{2} + \frac{{aC}_{1}}{2} ) {t}_{TTLC}^{2} = 0 \to \\ {t}_{TTLC} = \frac{- {C}_{1} V \pm \sqrt{( {C}_{1}^{2} {V}^{2} - 2 {aC}_{0} {C}_{1} - 4 {C}_{0} {C}_{2} {V}^{2} - 2 {C}_{0} V \dot{ψ} )}}{2 {C}_{2} {V}^{2} + V \dot{ψ} + {aC}_{1}}$$

A prediction model may then be defined based on the approximated TTLC from the kinematics model. In the exemplary embodiment below, the prediction model assumes linear propagation or integration of TTLC between consecutive time steps. In the below prediction model, vₓ refers to host vehicle velocity, ax refers to host vehicle acceleration, C₀ refers to relative distance of the host vehicle from the relevant lane marking, C₁ refers to heading of the lane relative to the host vehicle, and C₂ refers to curvature of the lane relative to the host vehicle.

$${v}_{{x}_{t + 1}} = {v}_{{x}_{t}} + {T}_{s} \cdot {a}_{{x}_{t}} + {T}_{s} \cdot \tilde{\dot{ψ}} \cdot {v}_{{y}_{t}} + {T}_{s} \cdot {v}_{a}$$

$${a}_{{x}_{t + 1}} = {a}_{{x}_{t}} + {T}_{s} \cdot {v}_{a}$$

$${C}_{{0}_{t + 1}} = {C}_{{0}_{t}} + {T}_{s} \cdot {v}_{{x}_{t}} \cdot {C}_{{1}_{t}} + {T}_{s}^{2} \cdot {v}_{{x}_{t}}^{2} \cdot {C}_{{2}_{t}} + {T}_{s}^{3} \cdot {v}_{{x}_{t}}^{3} \cdot {\tilde{C}}_{{3}_{t}} + {v}_{{C}_{0}}$$

$${C}_{{1}_{t + 1}} = {C}_{{1}_{t}} + 2 \cdot {T}_{s} \cdot {v}_{{x}_{t}} \cdot {C}_{{2}_{t}} + 3 \cdot {T}_{s}^{2} \cdot {v}_{{x}_{t}}^{2} \cdot {\tilde{C}}_{{3}_{t}} + {v}_{{C}_{1}}$$

$${C}_{{2}_{t + 1}} = {C}_{{2}_{t}} + 6 \cdot {T}_{s} \cdot {v}_{{x}_{t}} \cdot {\tilde{C}}_{{3}_{t}} + {v}_{{C}_{2}}$$

$${TTLC}_{t + 1} = {TTLC}_{t} + {T}_{s} \cdot \frac{d}{dt} ( \frac{N}{D} ) + {v}_{TTLC}$$

$$N = - {C}_{1} {v}_{x} \pm \sqrt{{C}_{1}^{2} {v}_{x}^{2} - 2 {a}_{x} {C}_{0} {C}_{1} - 4 {C}_{0} {C}_{2} {v}_{x}^{2} - 2 {C}_{0} {v}_{x} \tilde{\dot{ψ}} ,}$$

$$D = 2 {C}_{2} {v}_{x}^{2} + {v}_{x \tilde{\dot{ψ}}} + {a}_{x} {C}_{1} , \\ v = N ( 0 , σ ) .$$

The measurement model may subsequently be stated as:

vₓ_{ₜ}=vₓ_{ₜ}+ηᵥ_{ₓ},

C₀_{ₜ}=C₀_{ₜ}+η_{C}_{₀},

C₁_{ₜ}=C₁_{ₜ}+η_{C}_{₁},

C₂_{ₜ}=C₂_{ₜ}+η_{C}_{₂},

TTLCₜ=TTLCₜ+η_{tlc},

where

η= [symbol] (0,σ).

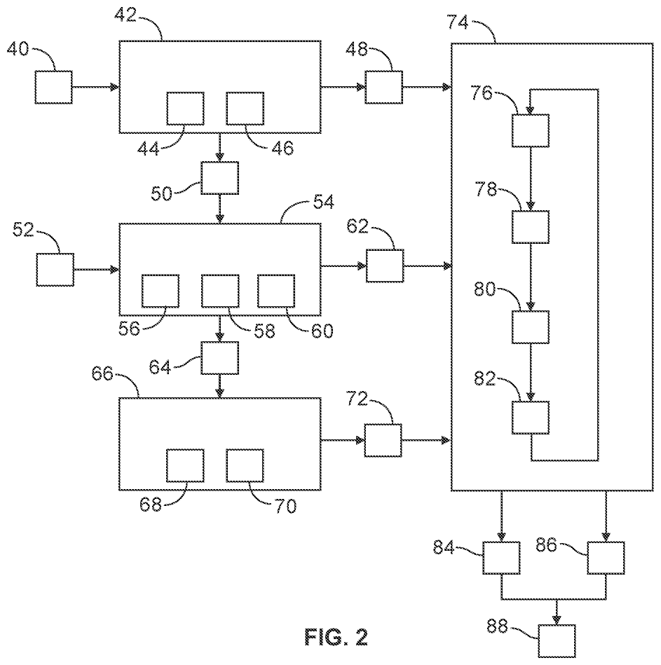

Use of such a kinematic model may enable more accurate and timely interventions, as will also be discussed in further detail below in conjunction with FIGS. 2-4.

Furthermore, the estimated TTLC may be filtered using an unscented Kalman Filter as follows. State sigma points are generated and augmented:

X_{t|t}^{a}=[X_{t|t},X_{t|t}+\sqrt{(λ+nₓ)·P_{t|t}},X_{t|t}−\sqrt{(λ+nₓ)·P_{t|t}}]

Sigma points for the next time step are calculated using the prediction model:

X_{t+1|t}^{a}=F(X_{t|t}^{a},v)

State mean and state covariance are predicted:

$${X}_{t + 1 \vert t} = {\sum }_{i = 1}^{{n}_{a}} {w}_{i} \cdot {X}_{t + 1 \vert t , i}^{a} , \\ {P}_{t + 1 \vert t} = {\sum }_{i = 0}^{2 {n}_{a}} {w}_{i} \cdot ( {X}_{t + 1 \vert t , i}^{a} - {x}_{t + 1 \vert t} ) \cdot {( {X}_{t + 1 \vert t , i}^{a} - {x}_{t + 1 \vert t} )}^{T}$$

Sigma points in the measurement space are then predicted using the measurement model:

$${Z}_{t + 1 \vert t}^{a} = H ( {Z}_{t \vert t}^{a} ) + η , \\ {z}_{t + 1 \vert t} = {\sum }_{i = 1}^{{n}_{a}} {w}_{i} \cdot {Z}_{t + 1 \vert t , i}^{a} , \\ {S}_{t + 1 \vert t} = {\sum }_{i = 0}^{2 {n}_{a}} {w}_{i} \cdot ( {Z}_{t + 1 \vert t , i}^{a} - {z}_{t + 1 \vert t} ) \cdot {( {Z}_{t + 1 \vert t , i}^{a} - {z}_{t + 1 \vert t} )}^{T}$$

The state and covariance matrix is then updated based on actual measurements:

Cross-correlation matrix: T_{t+1|t}=Σᵢ₌₀²ⁿ^{ₐ}wᵢ·(X_{t+1|t,i}^{a}−x_{t+1|t})·(Z_{t+1|t,i}^{a}−z_{t+1|t})^{T}

Kalman Gain: K_{t+1|t}=T_{t+1|t}·S_{t+1|t}⁻¹

Residual/Innovation: yₜ₊₁=z−z_{t+1|t}

Update State Matrix: x_{t+1|t+1}=x_{t+1|t}+K_{t+1|t}·yₜ₊₁

Update Covariance Matrix: P_{t+1|t+1}=P_{t+1|t}−K_{t+1|t}·S_{t+1|t}·K_{t+1|t}^{T}

As may be seen, the above-described schema predicts TTLC at subsequent time steps based on the measurement at a current time step. At the subsequent time steps, the prediction is updated while also updating covariance using cross-correlation between prediction models. Unexpected TTLC behavior may thereby be detected based on changes in other states. By using the covariance at each time step, a confidence parameter for the TTLC calculation at the corresponding time step is thereby obtained.

Referring now to FIG. 2, a system and method of controlling a vehicle according to the present disclosure is illustrated in logic diagram form. Vehicle kinematic parameters 40, including vehicle speed, acceleration, and yaw rate, are obtained. The kinematic parameters 40 may be obtained from one or more sensors, e.g. accelerometers or IMUS associated with the vehicle. The kinematic parameters are input to a trajectory approximation algorithm 42. The trajectory approximation algorithm 42 includes a vehicle model 44 and imposes vehicle motion constraints or physical constraints 46. The trajectory approximation algorithm outputs a vehicle state and trajectory parameter 48 and a predicted vehicle trajectory 50.

Lane criteria 52, including detected lane marking positions, lane headings, and lane curvature, are obtained. The lane criteria 52 may be obtained from one or more sensors, e.g. optical cameras or LiDAR. The lane criteria 52 and predicted vehicle trajectory 50 are input to a lane crossing calculation 54. The lane crossing calculation 54 includes an adjustment and transformation step 56, a distance to lane crossing formulation step 58, and a relative lane-vehicle model step 60. The lane crossing calculation outputs adjusted lane information 62 and a distance to lane crossing parameter 64.

The distance to lane crossing parameter 64 is input to a time to lane crossing calculation 66. The time to lane crossing calculation 66 includes a conditioning step 68 and a solver step 70. The time to lane crossing calculation 66 outputs a model-based approximated time to lane crossing 72.

The vehicle state and trajectory parameter 48, adjusted lane information 62, and time to lane crossing 72 are input to an estimation and confidence calculation 74, e.g. as shown in the equations above. The estimation and confidence calculation 74 includes a first step 76 for determination of augmented vehicle lane states and correlations, a second step 78 for prediction and state propagation, a third step 80 for updating the prediction based on measurements and model probabilities, and a fourth step 82 for checking estimation convergence. If unconverged, the calculation 74 returns to the first step 76. The estimation and confidence calculation 74 outputs a TTLC parameter 84 and an associated confidence factor 86. The confidence factor 86 indicates a confidence that the vehicle will cross a lane divider at the time indicated by the TTLC parameter 84.

The estimation and confidence calculation 74 thereby functions as a supervisory estimator, taking in a variety of information including its own estimate of the TTLC. By fusing vehicle kinematics and dynamics, lane information, and vehicle states with the supervisory estimator, the estimation and confidence calculation 74 may robustly filter non-plausible TTLC calculations and false lane departure predictions to provide accurate and continuous estimations of TTLC. Advantageously, the estimation and confidence calculation 74 is reconfigurable, e.g. easily modified to accommodate and include other inputs in place of, or in addition to, the vehicle state and trajectory parameter 48, adjusted lane information 62, and time to lane crossing 72.

The TTLC parameter 84 and confidence factor 86 are input to an intervention system 88. In a first exemplary embodiment, the intervention system 88 comprises a driver notification system configured to provide an audible, visible, haptic, or other notification to a driver to warn of an impending lane crossing. In a second exemplary embodiment, the intervention system 88 comprises a lane keep assist system configured to control the vehicle steering system, e.g. by applying a corrective steering torque via an actuator, to deter crossing a lane marker. In a third exemplary embodiment, the intervention system 88 comprises a lane centering system configured to control the vehicle steering system to maintain a desired lane, e.g. according to an automated driving system. In other embodiments, other intervention systems may be implemented.

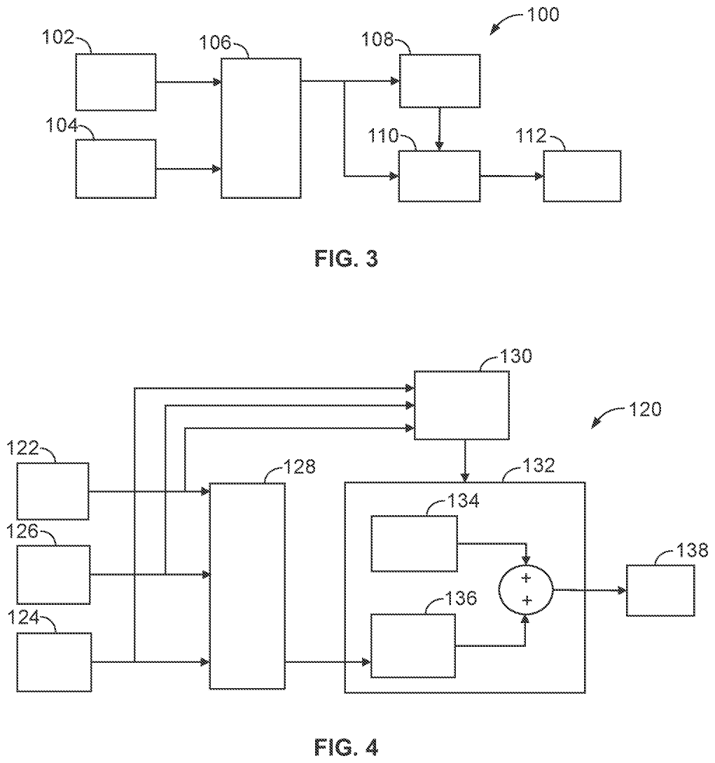

Referring now to FIG. 3, an exemplary embodiment of a lane keep assist system 100 according to the present disclosure is illustrated in schematic form. The lane keep assist system 100 includes a first sensor 102 configured to detect features exterior the vehicle. The first sensor 102 is arranged to detect information relating to vehicle lanes. In various exemplary embodiments, the first sensor 102 includes an optical camera, a LiDAR system, a RADAR system, other sensors, or a combination thereof. The lane keep assist system 100 additionally includes a second sensor 104 configured to detect vehicle kinematic parameters such as vehicle speed, acceleration, and yaw rate. In an exemplary embodiment, the second sensor 104 includes an accelerometer or IMU. A predictive TTLC algorithm 106, e.g. as discussed above, receives lane information from the first sensor 102 and kinematic parameters from the second sensor 104. The TTLC algorithm 106 outputs a TTLC parameter and confidence factor as discussed above with respect to FIG. 2. One or more intervention criteria 108 are evaluated to determine whether lane-keep-assist intervention is desirable. If the intervention criteria 108 are satisfied and lane-keep-assist intervention is desirable, then an activation command is passed to a lane keeping control algorithm 110. The lane keeping control algorithm 110 generates a steering command, e.g. a torque command or target steering angle command, and transmits the steering command to an actuator 112, e.g. a power steering system actuator.

Referring now to FIG. 4, an exemplary embodiment of a lane centering control system 120 is illustrated in schematic form. The lane centering control system 120 includes a first sensor 122 configured to detect features exterior the vehicle. The first sensor 122 is arranged to detect information relating to traffic lanes proximate the vehicle. In various exemplary embodiments, the first sensor 122 includes an optical camera, a LiDAR system, a RADAR system, other sensors, or a combination thereof. The lane centering control system 120 additionally includes a second sensor 124 configured to detect vehicle kinematic parameters such as vehicle speed, acceleration, and yaw rate. In an exemplary embodiment, the second sensor 124 includes an accelerometer or IMU. The lane centering control system 120 additionally includes a map 126 containing information relating to road curvature, e.g. stored in non-transient data memory. A predictive TTLC algorithm 128, e.g. as discussed above, receives lane information from the first sensor 122, kinematic parameters from the second sensor 124, and road curvature information from the map 126. The TTLC algorithm 128 outputs a TTLC parameter and confidence factor as discussed above with respect to FIG. 2. In addition, a mission planner algorithm, e.g. a path planning module of an automated driving system, receives the lane information from the first sensor 122, kinematic parameters from the second sensor 124, and road curvature information from the map 126. The mission planner algorithm 130 outputs a desired trajectory to a lane centering control algorithm 132. The lane centering algorithm 132 comprises a path following control module 134 and a lane departure mitigation control module 136. The lane departure mitigation control module 136 receives the TTLC parameter and confidence factor from the TTLC algorithm. The lane centering algorithm 132 incorporates output from the path following control module 134 and the lane departure mitigation control module 136 to generate a steering command, e.g. a torque command or target steering angle command, and transmits the steering command to an actuator 138, e.g. a power steering system actuator.

As may be seen the present disclosure provides a system and method for accurate and timely interventions based on anticipated departures from a current driving lane.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further exemplary aspects of the present disclosure that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. An automotive vehicle comprising:
at least one sensor configured to detect a lane marking in the vicinity of the vehicle, to detect velocity of the vehicle, to detect yaw rate of the vehicle, and to detect acceleration of the vehicle; and
a controller in communication with the at least one sensor and being configured to selectively control a steering intervention system in a first mode and a second mode, the controller being further configured to calculate a plurality of lane departure estimations at a corresponding plurality of time instances, arbitrate among the plurality of lane departure estimations to calculate a predictive time to lane departure, calculate a lane departure confidence value associated with the predictive time to lane departure, and, in response to the confidence value exceeding a first threshold and the predictive time to lane departure being below a second threshold, control the steering intervention system in the second mode.

2. The automotive vehicle of claim 1, wherein the controller is further configured to calculate a preliminary time to lane departure parameter based on a kinematic model, and to calculate the predictive time to lane departure and lane departure confidence value by filtering the preliminary time to lane departure parameter.

3. The automotive vehicle of claim 2, wherein the controller is further configured to filter the preliminary time to lane departure parameter using an estimation algorithm.

4. The automotive vehicle of claim 3, wherein the estimation algorithm comprises an unscented Kalman filter.

5. The automotive vehicle of claim 2, wherein the kinematic model is based on a measured velocity of the vehicle, a measured acceleration of the vehicle, a measured yaw rate of the vehicle, a detected lane marking location relative to the vehicle, a detected lane marking heading relative to the vehicle, and a detected lane curvature obtained from the at least one sensor.

6. The automotive vehicle of claim 1, wherein the steering intervention system comprises an auditory, visible, or haptic operator notification system, and wherein in the first mode the steering invention system does not provide a notification and in the second mode the steering intervention system provides a notification.

7. The automotive vehicle of claim 1, wherein the steering intervention system comprises at least one actuator configured to control vehicle steering, and wherein in the first mode the steering intervention system does not control the actuator to provide a steering torque and in the second mode the steering intervention system controls the actuator to provide a steering torque.

8. The automotive vehicle of claim 1, wherein the at least one sensor comprises an optical camera, a LiDAR system, or a RADAR system.

9. A method of controlling a host automotive vehicle comprising:
providing the host vehicle with at least one sensor, at least one controller, and a steering intervention system in communication with the at least one controller;
obtaining, from the at least one sensor, a measured velocity of the host vehicle, a measured acceleration of the host vehicle, a measured yaw rate of the host vehicle, a detected lane marking location relative to the host vehicle, a detected lane marking heading relative to the host vehicle, and a detected lane curvature;
calculating, via the at least one controller, a preliminary time to lane crossing parameter according to a kinematic model based on the measured velocity, measured acceleration, measured yaw rate, lane marking location, lane marking heading, and lane curvature;
filtering, via the at least one controller, the preliminary time to lane crossing parameter to obtain a final time to lane crossing value and a confidence parameter associated with the final time to lane crossing value; and
in response to the final time to lane crossing being below a first threshold and the confidence parameter exceeding a second threshold, automatically controlling, via the at least one controller, the steering intervention system in a steering intervention mode.

10. The method of claim 9, wherein the filtering comprises applying an unscented Kalman filter.

11. The method of claim 9, wherein the steering intervention system comprises an auditory, visible, or haptic operator notification system, and wherein controlling the steering intervention system in the steering intervention mode includes controlling the steering intervention system to provide a notification.

12. The method of claim 9, wherein the steering intervention system comprises at least one actuator configured to control vehicle steering, and wherein controlling the steering intervention system in the steering intervention mode includes controlling the steering intervention system to provide a corrective steering torque.

13. The method of claim 9, wherein the filtering comprises modifying one or more non-plausible time to lane crossing calculations.

14. The method of claim 9, further comprising fusing, via the at least one controller, the preliminary time to lane crossing parameter with vehicle kinematics information, vehicle dynamics information, vehicle state information, and host vehicle lane information.
